(19) United States
(12) Patent Application Publication
(10) Pub. No.: US 2019/0371189 A1
(43) Pub. Date: Dec. 5, 2019

(54) ENGAGEMENT MEASUREMENT SYSTEM

(71) Applicant: GAIA SYSTEM SOLUTIONS INC., Tokyo (JP)

(72) Inventors: Ryuichi HIRAIDE, Tokyo (JP); Mikio OKAZAKI, Tokyo (JP); Masami MURAYAMA, Tokyo (JP); Shouichi HACHIYA, Tokyo (JP)

(21) Appl. No.: 16/462,487

(22) PCT Filed: Nov. 22, 2017
(86) PCT No.: PCT/JP2017/042003

§ 371 Date: May 20, 2019

(30) Foreign Application Priority Data
Nov. 24, 2016 (JP) 2016-227698
Oct. 24, 2017 (JP) 2017-205034

(51) Int. Cl. G09B 5/00; G06K 9/00; G06T 7/73

(52) U.S. Cl. CPC G09B 5/00; G06K 9/00281; G06T 2207/30201; G06T 7/73; G06K 9/00315

(57) ABSTRACT

Provided is an engagement measurement system with which it is possible to measure and totalize how much students or an audience is interested in a lesson or a lecture in real time. An engagement measurement device captures images of a plurality of students who are subjects using a single or a small number of imaging devices, and measures an engagement value that indicates how much the students are interest in a lesson. The engagement measurement device records subject IDs, the date and time information, and the engagement value in a log table.

### TECHNICAL FIELD

The present invention relates to an engagement measurement system particularly suitable for a cram school and the like.

### BACKGROUND ART

Conventionally, “household audience rating” has been used as an index indicating how many viewers are watching video content broadcasted in television broadcasting (hereinafter, referred to as “TV broadcasting”). To measure the household audience rating in TV broadcasting, a device for measuring an audience rating is installed in a sample household, and transmits information on a channel indicating when a television receiver (hereinafter, referred to as “TV”) is in an on state to a totalizing base in substantially real time. That is, the household audience rating is a result obtained by totalizing information on a viewing time and a viewing channel, and it is not known, from the information such as the household audience rating, a state in which a viewer watches a program (video content).

For example, in the case of a viewing mode in which a viewer does not focus at a screen on which a TV program is displayed but listens to the TV program like a radio, the viewer watches the program without concentrating on the program. In such a viewing mode, advertising effects of commercials (hereinafter, referred to as “CM”) inserted between TV programs cannot be expected much.

Several technologies for finding out how much a viewer concentrates on TV programs have been studied.

Patent Literature 1 discloses a technology for defining how much a viewer focuses on a TV program as a “degree of concentration” and acquiring and using the degree of concentration.

### CITATION LIST

### Patent Literature

Patent Literature 1: JP 2003-111106 A

### SUMMARY OF INVENTION

### Technical Problem

The inventors have so far developed a device for measuring a degree of concentration. The inventors noticed during the development of the device that there are passive factors as well as active factors as factors that let a person concentrate on any event.

For example, an act of concentrating on solving problems that a person is challenging is the active factor. That is, the act is caused by the feeling such as “the event should be concentrated”. On the other hand, an act of making a person interested in events such as funny and entertaining events is the passive factor in a sense. That is, the act is caused by the feeling such as “a person is interested by the events unintentionally”.

The inventors have considered that it is not necessarily appropriate to express the acts caused by such conflicting feelings in the term “degree of concentration”. Therefore, the inventors have defined a state in which a target person is paying attention to a certain event as a word “engagement”, regardless of the active or passive factors. Then, the inventors have defined devices that have been developed so far as a device for measuring engagement, not a device for measuring a degree of concentration.

A system developed by the inventors described in this specification is a system for measuring the engagement.

Although it is assumed that the measurement of the engagement is applied to the above-mentioned TV broadcasting, in addition to this, various applications are considered. The inventors have now considered applying the measurement of the engagement to the field of education such as a cram school. That is, if it is possible to measure and totalize how much students are interested in a lesson in real time, it can contribute to improving the customer satisfaction or performance of the cram school.

So far, all systems for measuring a degree of concentration are expensive, and therefore there has been a problem in that it is difficult to spread the systems to a cram school and the like that need to introduce a large number of devices.

The present invention has been made in view of such problems, and an object of the present invention is to provide an engagement measurement system capable of measuring and totalizing how much students or an audience is interested in a lesson or a lecture in real time.

### Solution to Problem

In order to solve the above problem, an engagement measurement system of the present invention includes: an imaging device that captures images of faces of a plurality of subjects; and an engagement measurement device that receives a moving picture data stream from the imaging device to measure engagement values of the plurality of subjects.

The engagement measurement device includes a frame buffer that stores image data corresponding to one screen from an image data stream output from the imaging device; a face detection processing unit that detects whether there are the faces of the plurality of subjects from the image data stored in the frame buffer and outputs face detection address information for extracting only the faces of the plurality of subjects; and a feature point extraction unit that outputs feature point data, which are an aggregate of feature points having coordinate information in a two-dimensional space of the faces of a plurality of subjects, from the image data and the face detection address information stored in the frame buffer. In addition, the engagement measurement device includes: a vector analysis unit that generates a face direction vector indicating a face direction of the subject from the feature point data; an engagement calculation unit that calculates the face direction vector to calculate a focus direction vector indicating a location in a three-dimensional space at which the subject focuses, determines whether the e direction vector is directed to a predetermined event, and calculates a moving average of the determination results to output the engagement values; and an input/output control unit that operates the engagement calculation unit to calculate the engagement values for each of the plurality of subjects included in the image data based on the face detection address information and records capturing date and time information or current date and time information of the image data and ID information for uniquely identifying a plurality of subjects in the image data in a log table. In addition, the engagement measurement device includes an engagement average value calculation unit that calculates an average value of the engagement values; and a display unit that displays the average value of the engagement values of the plurality of subjects.

### Advantageous Effects of Invention

According to the present invention, it is possible to provide the engagement measurement system capable of measuring and totalizing how much students or an audience is interested in a lesson or a lecture in real time.

The problems, configurations, and effects other than those described above will be clarified from the description of the embodiments below.

### BRIEF DESCRIPTION OF DRAWINGS

FIG. 1 is a schematic view showing a state in which an engagement measurement system according to a first embodiment of the present invention is installed and operated in a predetermined cram school.

FIG. 2 is a schematic view showing an overall configuration of the engagement measurement system according to the first embodiment of the present invention.

FIG. 3 is an external view of the engagement measurement device configured by a notebook computer and a small single board computer.

FIG. 4 is a block diagram showing a hardware configuration of the engagement measurement device configured by a single board computer.

FIG. 5 is a block diagram showing a software function of the engagement measurement system according to the first embodiment of the present invention.

FIG. 6 is a schematic view showing an example of an image data stream output from an imaging device, a schematic view showing an example of a face extraction image data output from a face detection processing unit, and a schematic view showing an example of feature point data output from a feature point extraction unit.

FIG. 7 is a block diagram showing a hardware configuration of a server.

FIG. 8 is a block diagram showing a software function of the server.

FIG. 9 is a block diagram showing a hardware configuration of a monitor terminal.

FIG. 10 is a block diagram showing a software function of the monitor terminal.

FIG. 11 is a display example of a monitor screen displayed on a display unit of the monitor terminal.

FIG. 12 is a schematic view showing an overall configuration of an engagement measurement system according to a second embodiment of the present invention and a state in which the engagement measurement system is installed and operated in a predetermined cram school.

FIG. 13 is a block diagram showing a hardware configuration of an engagement measurement device.

FIG. 14 is a block diagram showing a software function of the engagement measurement device according to the second embodiment of the present invention.

FIG. 15 is a schematic view showing an example of image data corresponding to one screen which is output from an imaging device and stored in a frame buffer, a schematic view showing an example of face detection address information output from a face detection processing unit, and a schematic view showing an example of feature point data output from a feature point extraction unit.

FIG. 16 is an image diagram showing a state in which the face detection processing unit generates the face detection address information for the image data stored in the frame buffer and a state in which the face detection processing unit has generated the face detection address information.

FIG. 17 is a functional block diagram of an engagement calculation unit.

FIG. 18 is a diagram showing a field configuration of a log table.

FIG. 19 is a display example of a monitor screen displayed on a display unit by an input/output unit of the engagement measurement device.

### DESCRIPTION OF EMBODIMENTS

The applicant early filed a patent application for a degree of concentration processing system for capturing an image of a user who watches content with a camera and calculating the degree of concentration from a face direction and a line-of-sight direction of a user (Japanese Patent Application No. 2016-124611, hereinafter, referred to as “First patent application”). The degree of concentration processing system according this first patent application captures an image of a user's face with a camera, detects a face direction and a line-of-sight direction of the user, and measures how much those directions are directed to a display displaying content, thereby calculating the degree of concentration for the content of the user.

A first embodiment to be described below relates to an engagement measurement system and an engagement measurement device which improve the degree of concentration processing system disclosed in the first patent application and is constructed as an application for a cram school and the like.

The engagement measurement system according to the first embodiment installs an engagement measurement device with a camera built therein in the vicinity of students to measure engagement values of the students and adds up average values of the engagement values. In addition, the engagement measurement device measures the engagement value of one student reflected in the built-in camera.

A second embodiment to be described next to the first embodiment relates to an engagement measurement system which further improves the engagement measurement system according to the first embodiment and is constructed to realize a simpler system configuration. That is, instead of arranging one camera for one student or one audience, one high-resolution camera for capturing an image of an entire classroom or auditorium is provided, and engagement values of a plurality of persons are measured with one camera.

### First Embodiment: Installation and Operation Example

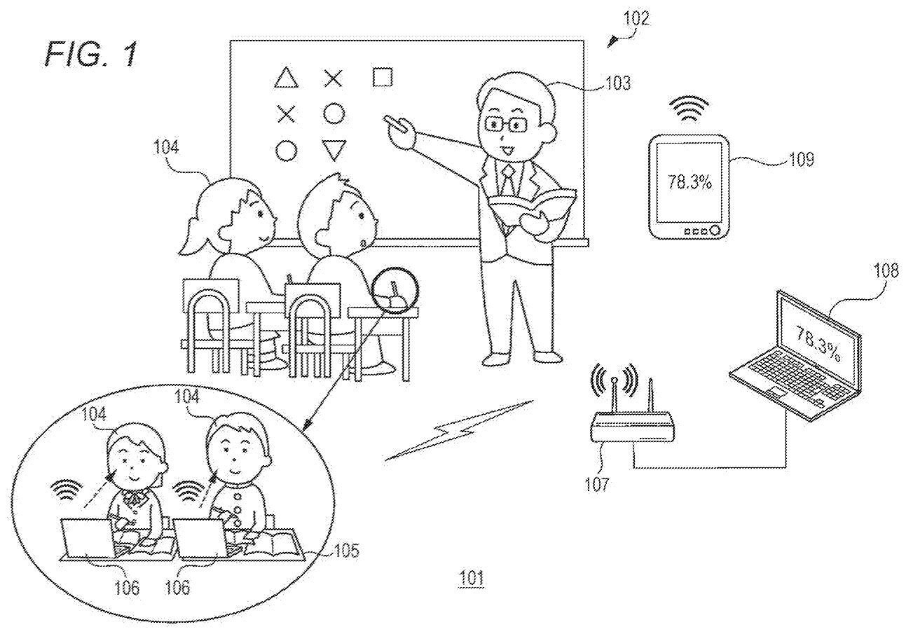

FIG. 1 is a schematic view showing a state in which an engagement measurement system 101 according to a first embodiment of the present invention is installed and operated in a predetermined cram school.

In a cram school 102, a lecturer 103 is teaching students 104. At this time, an engagement measurement system 101 is provided with an engagement measurement device 106, which is a notebook computer, to display predetermined teaching materials or the like on a desk 105 of the student 104 and measure engagement.

A camera is mounted on or embedded in a frame of an LCD display of the engagement measurement device 106, so the camera can capture images of faces of the students 104.

The engagement measurement device 106 is operated by an engagement measurement program to be described later, measures an engagement value of the student 104 in real time, and transmits the measured engagement value to a server 108 via a wireless LAN. The engagement values of each student 104 are logged in the server 108 connected to a wireless LAN router 107. In FIG. 1, the server 108 is configured by a notebook computer.

In addition, a monitor terminal 109, which is a tablet PC, accesses the server 108 via the wireless LAN all the times, receives the engagement values of each student 104 and a totalized value, and displays the received values on a liquid crystal display. The lecturer 103 can confirm the engagement in real time during a lesson by watching the monitor terminal 109.

Although described later with reference to FIG. 8, the monitor terminal 109 and the server 108 can be used together. That is, the notebook computer can be operated with both functions as a server 108 and as a monitor terminal 109.

Although not shown in FIG. 1, the engagement measurement system 101 according to the first embodiment of the present invention can be implemented in the same manner as the above-described cram school 102 even in a satellite lesson developed on the Internet.

[Overall Configuration]

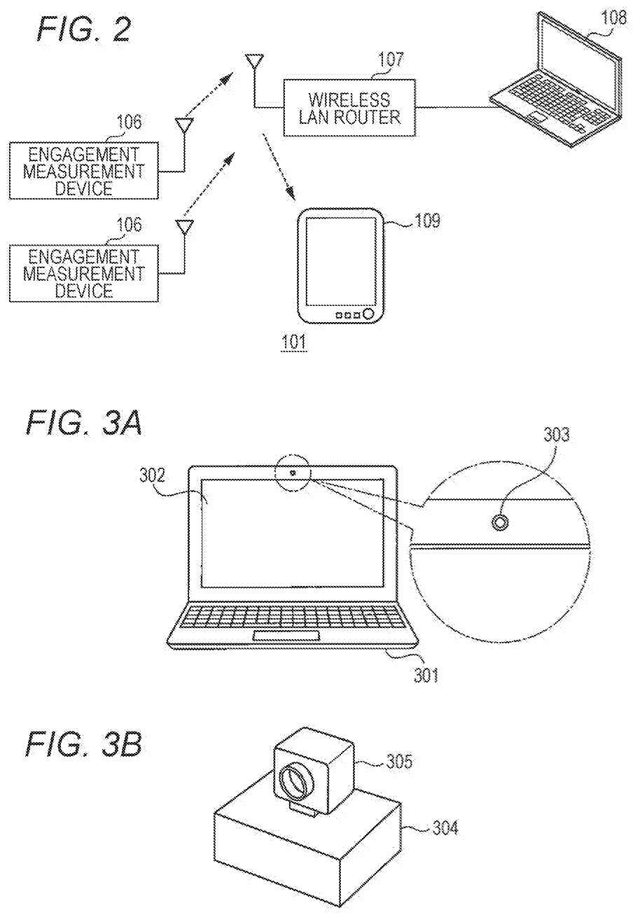

FIG. 2 is a schematic view showing an overall configuration of the engagement measurement system 101 according to the first embodiment of the present invention.

The engagement measurement device 106, the server 108, and the monitor terminal 109 are connected to each other via the wireless LAN router 107. Here, the wireless LAN router 107 configures a small scale LAN. Instead of the wireless LAN router 107, a switching hub or the like may be used to connect all of the engagement measurement device 106, the server 108, and the monitor terminal 109 to each other via a wired LAN.

In the case of the satellite lesson, a communication course or the like, the engagement measurement device 106 and the server 108 are connected to each other by the Internet instead of the LAN.

The notebook computer configuring the engagement measurement device 106 runs an engagement measurement program to be described later, measures the engagement value of the student 104 in real time, and transmits the measured engagement to the server 108 via the wireless LAN.

The server 108 logs the engagement value received from the engagement measurement device 106.

The monitor terminal 109 accesses the server 108, receives the engagement value output from the predetermined engagement measurement device 106, calculates the totalized value, and displays the calculated totalized value on the liquid crystal display in real time.

[Engagement Measurement Device 106: Appearance]

The engagement measurement device 106 is not necessarily configured by the notebook computer, but can be configured by, for example, a single-board computer which is rapidly becoming popular in recent years.

FIG. 3A is an external view of the engagement measurement device 106 configured by a notebook computer 301.

A network OS and a program for operating the notebook computer 301 as the engagement measurement device 106 are installed in the notebook computer 301.

A web camera 303 used for video chat or the like is mounted on or embedded in a frame of an LCD display 302 of the notebook computer 301. When the notebook computer 301 is placed on the desk 105 of the student 104, the web camera 303 captures the image of the face of the student 104, so the engagement value of the student 104 can be measured.

FIG. 3B is an external view of the engagement measurement device 106 configured by a small single board computer 304.

The network OS and a program for operating the single board computer 304 as the engagement measurement device 106 are installed in the single board computer 304.

When the single board computer 304 is placed on the desk of the student 104, the camera 305 mounted on a housing of the single board computer 304 captures the image of the face of the student 104, so it is possible to measure the engagement of the student 104.

As the single board computer 304, for example, “Raspberry Pi” developed by Raspberry Pi Foundation (http://www.raspberrypi.org/) in the UK can be used. An arithmetic processing capability of the single board computer 304 may be enough that the network OS such as Linux (registered trademark) can be operated at a practical speed.

[Engagement Measurement Device 106: Hardware Configuration]

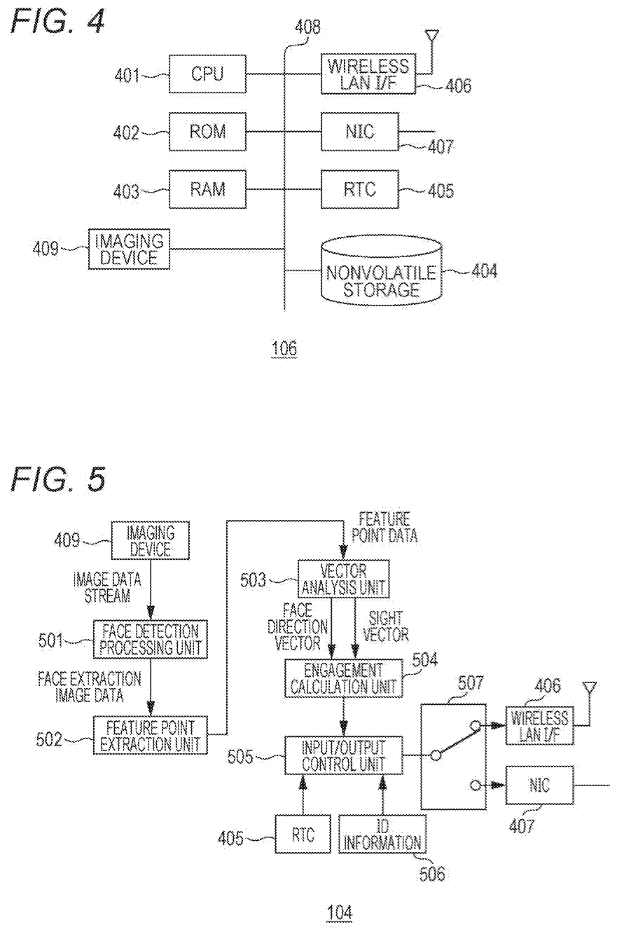

FIG. 4 is a block diagram showing a hardware configuration of the engagement measurement device 106 configured by the single board computer 304.

The engagement measurement device 106 includes a CPU 401, a ROM 402, a RAM 403, a nonvolatile storage 404, a real time clock (hereinafter, referred to as “RTC”) 405 that outputs current date and time information, a wireless LAN interface 406 for connecting to a wireless LAN router 107 and the like and a network interface card (NIC) 407 is connected to a bus 408. An imaging device 409 (web camera 303 or camera 305) playing an important role in the engagement measurement device 106 is also connected to the bus 408.

To connect the single board computer 304 to the network, a network OS including a TCP/IP protocol stack and a program for operating as the engagement measurement device 106 are stored in the nonvolatile storage 404.

When the engagement measurement device 106 is configured by the notebook computer 301, the engagement measurement device 106 is further configured to connect the display unit as the liquid crystal display and an operation unit as a pointing device such as a keyboard or a mouse to the bus 408 of FIG. 4.

[Engagement Measurement Device 106: Software Function]

FIG. 5 is a block diagram showing a software function of the engagement measurement device 106 according to the first embodiment of the present invention.

The image data stream output from the imaging device 409 is supplied to a face detection processing unit 501.

The face detection processing unit 501 captures the image data stream output from the imaging device 409 as a continuous still image on a time base, and detects whether the face of the student 104 is present in each image data of the continuous still image on the time base by using the known algorithm such as a Viola-Jones method. Then, a face extraction image data obtained by extracting only the face of the student 104 is output.

The face extraction image data output from the face detection processing unit 501 is supplied to a feature point extraction unit 502.

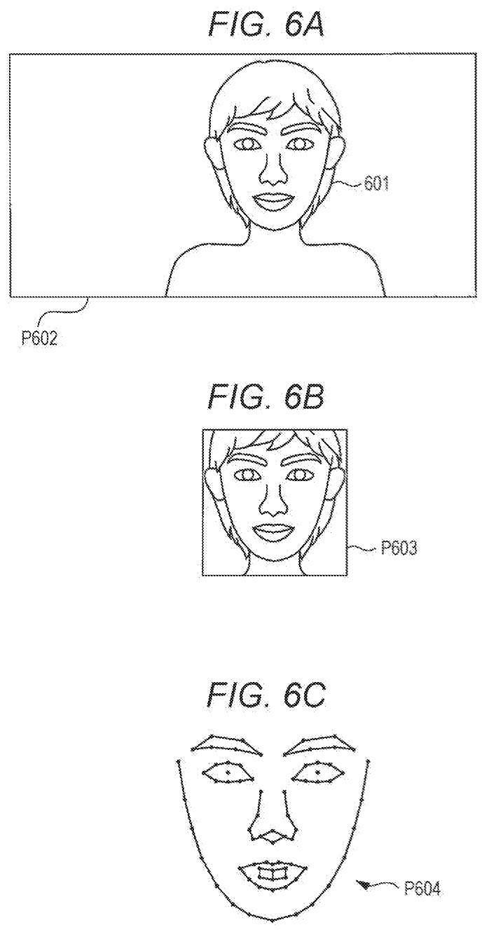

The feature point extraction unit 502 performs processing, such as polygon analysis, on the image of the face of the student 104 included in the face extraction image data. Then, feature point data which include contours of the whole face, eyebrows, eyes, nose, mouth, and the like of the student 104 and feature points of the face indicating a pupil are generated. Details of the feature point data will be described later with reference to FIG. 6.

The feature point data output from the feature point extraction unit 502 are supplied to a vector analysis unit 503. The vector analysis unit 503 generates a vector (hereinafter, referred to as a “face direction vector”) indicating the face direction of the student 104 and a vector (hereinafter, referred to as a “line-of-sight direction vector”) indicating a line-of-sight direction of the face of the student 104 are generated from the feature point data based on two continuous face extraction image data.

The face direction vector and the line-of-sight direction vector are supplied to an engagement calculation unit 504. The engagement calculation unit 504 adds the face direction vector and the line-of-sight direction vector to calculate a focus direction vector indicating a location in a three-dimensional space including the display displaying content and the imaging device 409 at which the student 104 focuses, and determines whether the focus direction of the student 104 is directed to the display. This determination result is a binary value indicating whether or not the focus direction of the student 104 is directed to the display (logic “true”) or (logic “false”).

The engagement calculation unit 504 calculates this focus direction determination result, for example, every 100 msec. For example, a moving average of the focus direction determination results for the last one second is calculated. By performing the calculation in this manner, it is possible to obtain the binary focus direction determination results as pseudo-analog values. The moving average value of the focus direction determination results is the engagement value.

The engagement value output from the engagement calculation unit 504 is supplied to an input/output control unit 505.

The input/output control unit 505 adds current date and time information and ID information 506 output from the RTC 405 to the engagement value to generate a transmission packet.

The transmission packet is transmitted to the server 108 of the wireless LAN interface 406 or the NIC 407 connected to the network through an interface selection unit 507 using a hypertext transfer protocol (HTTP). That is, the input/output control unit 505 has a function as a web client.

An entity of the interface selection unit 507 is a TCP/IP protocol stack and a dynamic host configuration protocol (DHCP) client that are provided in the OS. That is, the interface selection unit 507 selects a network interface connected to an IP reachable network, and transmits the transmission packet to the server 108.

In the engagement measurement device 106 according to the first embodiment of the present invention, the simplest and easy-to-handle HTTP is exemplified in the protocol used for communication in the network, but the protocol for transmitting the data stream is limited thereto.

[As to Transmission Data]

The transmission packet includes the current date and time information and the ID information 506 output from the RTC 405, in addition to the engagement value measured every 100 msec.

The engagement values output from the plurality of engagement measurement devices 106 and the average values thereof are displayed on the display screen of the monitor terminal 109 described later in real time. Since the network has a delay, by adding the current date and time information to the measured engagement value, it is possible to align time bases of the engagement values output from the plurality of engagement measurement devices 106. Further, for this purpose, it is preferable that a program having a date and time information calibration function such as a network time protocol (NTP) client is installed and executed in the engagement measurement device 106 to keep the RTC 405 correctly.

In addition, a plurality of engagement measurement devices 106 is installed in accordance with the number of students 104. The server 108 needs information for uniquely identifying each engagement measurement device 106 in order to simultaneously receive engagement values from the plurality of engagement measurement devices 106. For this reason, the ID information 506 for uniquely identifying the engagement measurement device 106 and/or the student 104 is provided. When the engagement measurement system 101 according to the first embodiment of the present invention is used in the cram school 102 or the like, only in the case where the identification of the student 104 who is the user is not required at all, instead of the ID information 506, the dynamic IP address imparted by a DHCP server can be used in the NIC 407 or the wireless LAN interface 406 of the engagement measurement device 106 as the information for uniquely identifying the engagement measurement device 106. When the IP address is used instead of the ID information 506, the IP address is included in a header of an IP packet, so a payload of the transmission packet includes only the current date and time information and the engagement value.

[As to Feature Point Data]

Operations of the face detection-processing unit 501, the feature point extraction unit 502, and the vector analysis unit 503 will be described below.

FIG. 6A is a schematic view showing an example of the image data stream output from the imaging device 409. FIG. 6B is a schematic view showing an example of the face extraction image data output from the face detection processing unit 501. FIG. 6C is a schematic view showing an example of the feature point data output from the feature point extraction unit 502.

First, an image data stream including a subject 601 is output from the imaging device 409 in real time. This is an image data P602 of FIG. 6A.

Next, the face detection processing unit 501 detects whether there is a face of the subject 601 from the image data P602 output from the imaging device 409 by using the known algorithms such as the Viola-Jones method. Then, a face extraction image data obtained by extracting only the face of the subject 601 is output. This is a face extraction image data P603 of FIG. 6B.

The feature point extraction unit 502 performs processing, such as polygon analysis, on the image of the face of the subject 601 included in the face extraction image data P603. Then, feature point data which include contours of the whole face, eyebrows, eyes, nose, mouth, and the like of the subject 601, and feature points of the face indicating a pupil are generated. This is a feature point data P604 of FIG. 6C. The feature point data P604 is configured by an aggregate of feature points having coordinate information in a two-dimensional space.

As described above, the feature point data output from the feature point extraction unit 502 is two-dimensional coordinate information. Since the image data stream output from the imaging device 409 as a single-eye camera is only two-dimensional image data, it is not possible to detect a face direction of the subject 601 which is a three-dimensional solid.

However, if it is assumed that two-dimensional image data in which feature points are reflected are obtained by capturing feature points plotted on a 3D model of a standard face, it is possible to estimate the captured face direction or a distance to a camera by the calculation.

Such a technology for estimating a three-dimensional solid from a two-dimensional image is known as a perspective n points (PnP) problem. The calculation method for solving the PnP problem is already known by a direct linear transform (DLT) method and the like.

By solving the PnP problem, the face direction of the subject 601 (see FIG. 6A) can be calculated. This is the face direction vector.

In addition, it is possible to calculate the approximate line-of-sight direction with respect to the face of the subject 601 from the position of the pupil with respect to the contour of the eye. This is the line-of-sight direction vector.

The vector analysis unit 503 generates the face direction vector and the line-of-sight direction vector from the feature point data by the above-described processing.

[Server 108: Hardware Configuration]

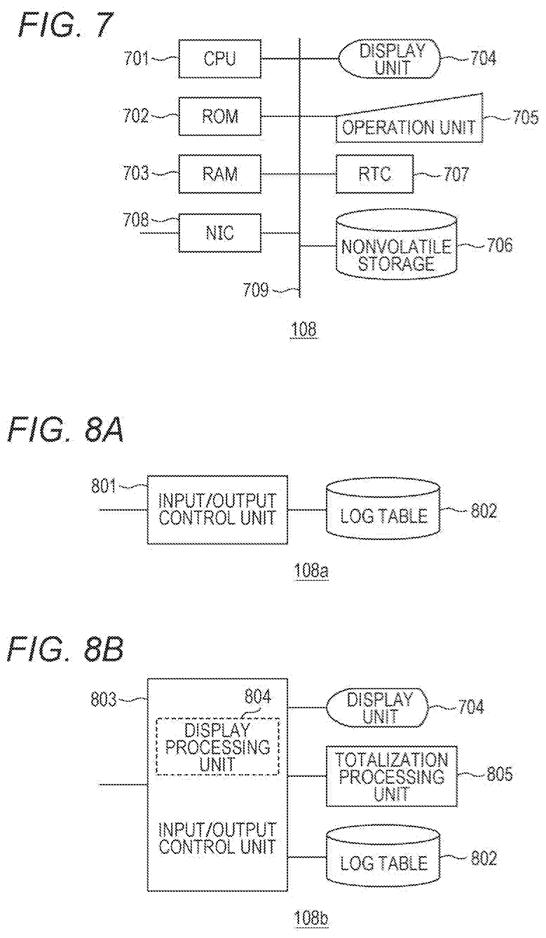

FIG. 7 is a block diagram showing a hardware configuration of the server 108.

In the server 108, a CPU 701, a ROM 702, a RAM 703, a display unit 704, an operation unit 705, a nonvolatile storage 706, an RTC 707, and an NIC 708 are connected to a bus 709. In the server 108, a notebook computer as shown in FIGS. 1 and 2, a desktop computer (not shown) or the like can be used. Further, the above-described single board computer can also be used as long as a large-capacity hard disk device can be used as the nonvolatile storage 706.

In order to connect the server 108 to the network, a network OS including a TCP/IP protocol stack and a program for operating as the server 108 are stored in the nonvolatile storage 706.

When the server 108 is running on the notebook computer, the wireless LAN interface is often connected to the bus 709.

The display unit 704 and the operation unit 705 are not necessarily required when the server 108 is specialized to the function as a server. However, when the server 108 and the monitor terminal 109 are together used in the notebook computer, the display unit 704 and the operation unit 705 are required.

[Server 108: Hardware Function]

FIG. 8A is a block diagram showing a software function of a server 108a.

The server 108a has a function as a web server and a function as a data base server.

An entity of an input/output control unit 801 is a web server program, and the input/output control unit 801 receives a request from the engagement measurement device 106 or the monitor terminal 109 which is the HTTP client, and returns response data in response to the request.

The information including the engagement value transmitted from the engagement measurement device 106 is recorded in a log table 802 provided in the nonvolatile storage 706 through the input/output control unit 801.

The input/output control unit 801 returns the engagement values of all the engagement measurement devices 106 together with the date and time information and the ID information 506 in response to the request of the engagement values of all the engagement measurement devices 106 received from the monitor terminal 109.

FIG. 8B is a block diagram showing a software function of a server 108b that also functions as the monitor terminal 109.

A difference between the server 108b shown in FIG. 8B and the server 108a shown in FIG. 8A is that an input/output control unit 803 includes a function of a display processing unit 804 for generating the content to be displayed on the display unit 704 and a totalization processing unit 805 and the display unit 704 are connected to the input/output control unit 803.

An entity of the input/output control unit 803 is a web server program, and the input/output control unit 803 receives the transmission packet transmitted from the engagement measurement device 106 which is the HTTP client.

The engagement value, the date and time information, and the ID information 506 included in the transmission packet transmitted from the engagement measurement device 106 are recorded in the log table 802 through the input/output control unit 803. In addition, the totalization processing unit 805 calculates the average values of the plurality of engagement values having the aligned time bases.

The display processing unit 804 generates a display content based on the engagement values and the average values of all the engagement measurement devices 106, and causes the display unit 704 to display the generated display content.

[Monitor Terminal 109: Hardware Configuration]

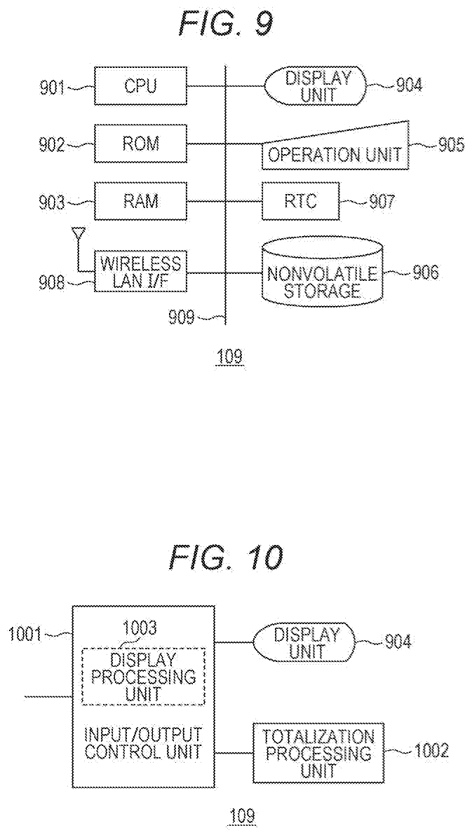

FIG. 9 is a block diagram showing a hardware configuration of the monitor terminal 109.

In the monitor terminal 109, a CPU 901, a ROM 902, a RAM 903, a display unit 904, an operation unit 905, a nonvolatile storage 906, an RTC 907, and a wireless LAN interface 908 are connected to a bus 909.

In order to connect the server 108 to the network, a network OS including a TCP/IP protocol stack and a program for operating as the monitor terminal 109 are installed in the nonvolatile storage 906.

A difference between the monitor terminal 109 as a tablet PC and the hardware configuration of the server 108 shown in FIG. 7 is that the NIC 708 replaces the wireless LAN interface 908. If the notebook computer is used instead of the tablet PC, the configuration is the same as that shown in FIG. 7.

[Monitor Terminal 109: Software Function]

FIG. 10 is a block diagram showing a software function of the monitor terminal 109.

An entity of the input/output control unit 1001 is a web server client, and transmits a request for returning the engagement values of all the engagement measurement devices 106 to the server 108 which is the web server. Then, the engagement values of all the engagement measurement devices 106 returned from the server 108 are received.

Similar to the totalization processing unit 805 in FIG. 8B, a totalization processing unit 1002 aligns time bases of the plurality of received engagement values, and then calculates average values thereof.

Similarly to the display processing unit 804 in FIG. 8B, the display processing unit 1003 generates a display content based on the engagement values and the average values of all the engagement measurement devices 106, and causes the display unit 704 to display the generated display content.

[Monitor Terminal 109: Display Example]

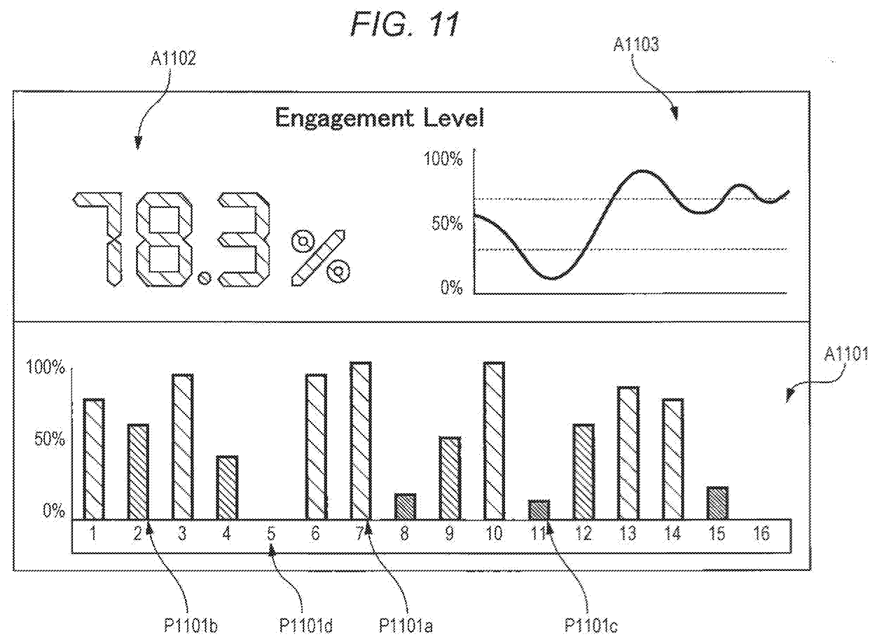

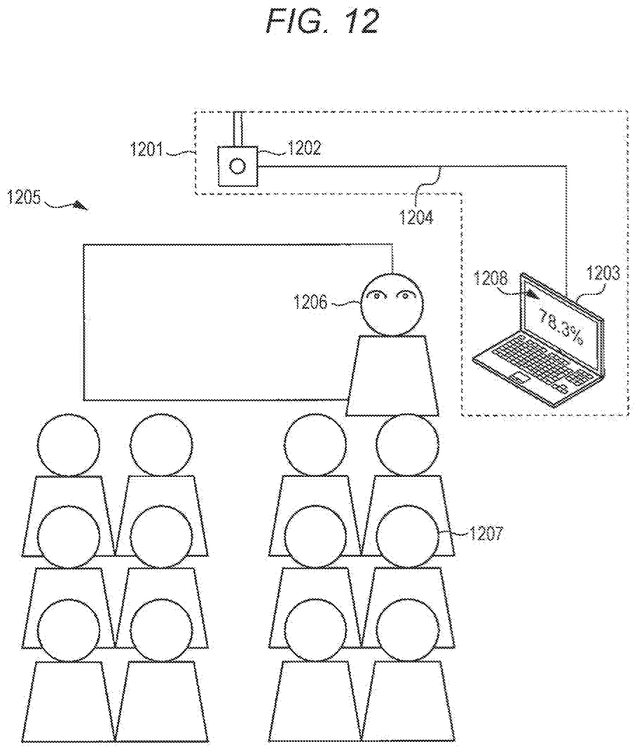

FIG. 11 is a display example of a monitor screen displayed on the display unit 704 of the monitor terminal 109.

A display area A1101 in the lower half of the screen is a bar graph of the engagement values output from all the engagement measurement devices 106. The bar graph is refreshed, for example, every second or every 0.5 seconds, and the latest engagement value at that time is represented by the bar graph. When the engagement value is 66.6% or more, the bar graph is represented in green (color P1101a), and when the engagement value is 33.3% or more and less than 66.6%, the bar graph is represented in orange (color P1101b), and when the engagement value is less than 33.3%, the bar graph is represented in red (color P1101c). In this manner, by displaying the engagement values in different colors, it is possible to instantly grasp the state of the engagement values of the student 104.

Numbers represented below the bar graph are numbers for uniquely identifying the engagement measurement device 106. The numbers are also represented in the same color as the bar graph. A number assigned to the engagement measurement device 106, which represents the absence of the student 104 and which cannot measure the engagement value, is represented in gray (color P1101d).

For example, when all the students 104 are interested in a lesson, all bar graphs are dyed green simultaneously except for a column of the engagement measurement device 106 which represents the absence.

For example, when many of the students 104 lose their concentration on a lesson, many bar graphs are dyed orange or red.

A display area A1102 in an upper left of the screen displays the average values of the engagement values output from all the engagement measurement devices 106 as numerical values. The numerical values are also represented in the same color as a line graph.

A display area A1103 in an upper right of the screen is a line graph representing a transition of the average values of the engagement values output from all the engagement measurement devices 106. A horizontal axis is time, and a vertical axis is the engagement value. Since not only a current value of the engagement value but also the transition of the engagement value can be grasped by providing the line graph, the lecturer 103 can grasp how much the students 104 are interested in a current lecture or which topic the students 104 are interested in or is not interested in.

The engagement value logged in the server 108 includes absolute time information, and therefore can be reproduced by the monitor terminal 109 later. In addition, if a lesson is recorded by a separate moving picture camera and information on date and time when recording starts is added to moving picture data, synchronous reproduction with the engagement value recorded in the log table 802 is also possible.

In the first embodiment of the present invention, the engagement measurement system 101 has been disclosed.

The engagement measurement device 106 measures the engagement value indicating how much the student 104 who is a subject is interested in a lesson, and transmits the measured engagement value to the server 108. The server 108 receives the transmission packet including the engagement values, the date and time information, and the ID information 506 transmitted from the plurality of engagement measurement devices 106, and records the received transmission packet in the log table 802. The monitor terminal 109 graphically displays, in real time, the engagement values and the average values thereof which are transmitted from the plurality of engagement measurement devices 106.

The arithmetic processing of the engagement measurement device 106 in the first embodiment of the present invention is extremely simple as compared with the related art. In addition, the data transmitted from the engagement measurement system 101 are the engagement value, the date and time information, and the ID information 506, which have an extremely small data capacity. Therefore, the amount of data that the engagement measurement system 101 transmits to the LAN and/or the Internet is extremely small.

### Second Embodiment: Engagement Measurement System 1201: Overall Configuration and Installation Operation Example

FIG. 12 is a schematic view showing an overall configuration of an engagement measurement system 1201 according to a second embodiment of the present invention and a state in which the engagement measurement system 1201 is installed and operated in a predetermined cram school.

The engagement measurement system 1201 includes an imaging device 1202 and an engagement measurement device 1203. The imaging device 1202 and the engagement measurement device 1203 are connected to each other by a cable 1204 such as a USB or a network.

In a classroom 1205 of a cram school, a lecturer 1206 is teaching a student 1207. The imaging device 1202 is installed on a ceiling of the classroom 1205 The imaging device 1202 can capture images of faces of a plurality of students 1207 sitting in the classroom 1205 in accordance with an angle of view and a resolution of the imaging device 1202.

The engagement measurement device 1203 runs an engagement measurement program to be described later, measures engagement values of the plurality of students 1207 in real time, and causes a display unit 1208 to display the measured engagement values. In FIG. 12, the engagement measurement device 1203 is configured by a notebook computer.

[Engagement Measurement Device 1203: Hardware Configuration]

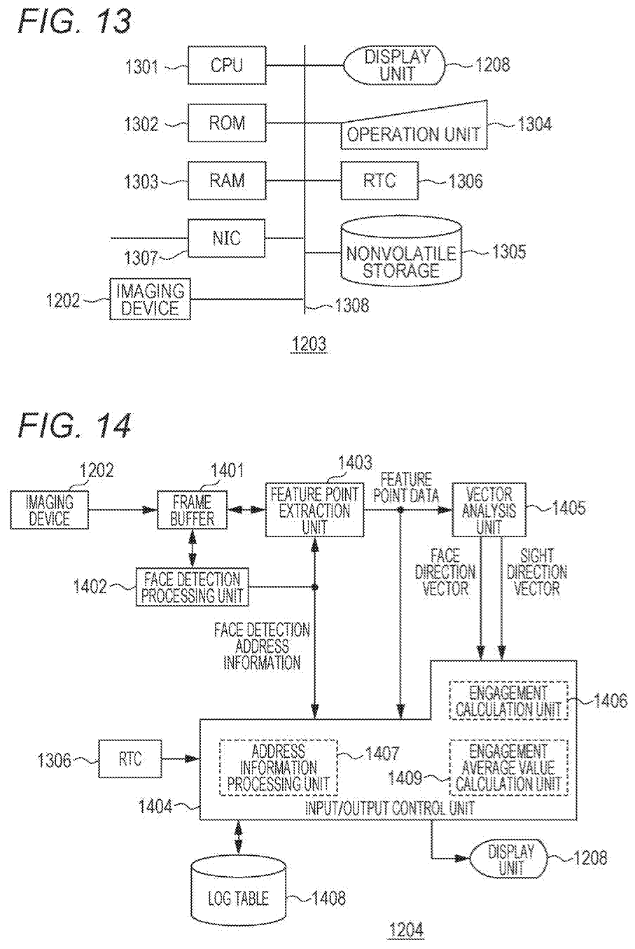

FIG. 13 is a block diagram showing a hardware configuration of the engagement measurement device 1203.

The engagement measurement device 1203 includes a CPU 1301, a ROM 1302, a RAM 1303, a display unit 1208, an operation unit 1304, a nonvolatile storage 1305, a real time clock (hereinafter, referred to as “RTC”) 1306 for outputting current date and time information, and a network interface card (NIC) 1307, all of them are connected to a bus 1308. In the engagement measurement device 1203, a notebook computer as shown in FIG. 12 or a desktop computer (not shown) or the like can be used.

To connect the engagement measurement device 1203 to the network, the nonvolatile storage 1305 stores a network OS including a TCP/IP protocol stack and a program for operating as the engagement measurement device 1203.

The imaging device 1202 playing an important role in the engagement measurement device 1203 is also connected to the bus 1308.

When a distance between the imaging device 1202 and the engagement measurement device 1203 is long, the known USB interface has a maximum cable length of 5 m, and the installation location of the engagement measurement device 1203 is highly likely to be restricted. In such a case, the imaging device 1202 is equipped with a signal board computer, and a network connects the engagement measurement device 1203 and the signal board computer to each other.

The moving image data stream output from the imaging device 1202 is transmitted to the engagement measurement device 1203 via the network. By doing so, it is possible to achieve a state in which a cable length is extended.

In the engagement measurement system 1201 of the present invention, the network function is not necessarily required in the engagement measurement device 1203 but may be necessary for the reasons as described above.

[Engagement Measurement Device 1203: Software Function]

FIG. 14 is a block diagram showing a software function of an engagement measurement device 1203 according to the second embodiment of the present invention.

In the image data stream output from the imaging device 1202, the image data corresponding to one screen are once stored in a frame buffer 1401.

The face detection-processing unit 1402 detects whether there are the faces of all the students 1207 reflected in the image data corresponding to one screen stored in the frame buffer 1401 by using the known algorithm such as a Viola-Jones method. In order to extract only the face of the student 1207, the face detection address information is output.

The face detection address information is supplied to a feature point extraction unit 1403 and an input/output control unit 1404.

The feature point extraction unit 1403 reads the face extraction image data obtained by extracting only the face of the student 1207, from the frame buffer 1401 based on the face detection address information obtained from the face detection processing unit 1402. The feature point extraction unit 1403 performs processing, such as the polygon analysis, on the image of the face of the student 1207 included in the face extraction image data. The polygon analysis processing is processing of generating the feature point data which includes contours of the whole face, eyebrows, eyes, nose, mouth, and the like of the student 1207 and the feature points of the face indicating a pupil.

The feature point data output from the feature point extraction unit 1403 are supplied to a vector analysis unit 1405.

The vector analysis unit 1405 generates the vector (hereinafter, referred to as a “face direction vector”) indicating the face direction of the student 1207 and the vector (hereinafter, referred to as a “line-of-sight direction vector”) indicating the line-of-sight direction of the face of the student 1207 from the feature point data based on the face extraction image data.

As described above, the feature point data output from the feature point extraction unit 1403 is the two-dimensional coordinate information. Since the image data stream output from the imaging device 1202 as a single-eye camera is only two-dimensional image data, it is not possible to detect a face direction of the student 1207 which is a three-dimensional solid.

However, if it is assumed that two-dimensional image data in which feature points are reflected are obtained by capturing feature points plotted on a 3D model of a standard face, it is possible to estimate the captured face direction or a distance to a camera by the calculation.

Such a technology for estimating a three-dimensional solid from a two-dimensional image is known as a perspective n points (PnP) problem. The calculation method for solving the PnP problem is already known by a direct linear transform (DLT) method and the like.

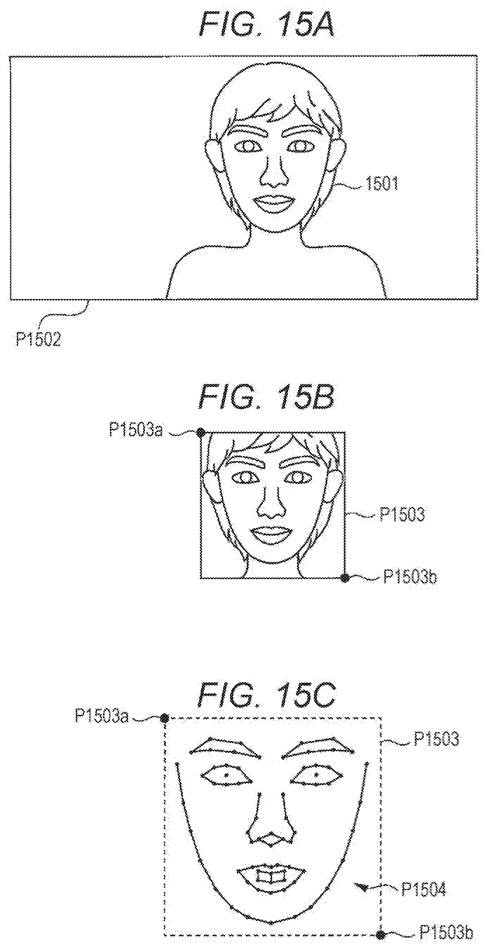

By solving the PnP problem, a face direction of a subject 1501 (see FIG. 15A) can be calculated. This is the face direction vector.

In addition, it is possible to calculate the approximate line-of-sight direction for the face of the subject 1501 from the position of the pupil with respect to the contour of the eye. This is the line-of-sight direction vector.

The vector analysis unit 1405 generates the face direction vector and the line-of-sight direction vector from the feature point data by the above-described processing.

[As to Feature Point Data]

Operations of the face detection processing unit 1402, the feature point extraction unit 1403, and the vector analysis unit 1405 will be described below.

FIG. 15A is a schematic view showing an example of the image data corresponding to one screen which is output from the imaging device 1202 and stored in the frame buffer 1401. FIG. 15B is a schematic view showing an example of the face extraction address information output from the face detection processing unit 1402. FIG. 15C is a schematic view showing an example of the feature point data output from the feature point extraction unit 1403.

First, the image data stream including a subject 1501 output from the imaging device 1202 is output in real time and is stored in the frame buffer 1401. This is an image data P1502 of FIG. 15A.

Next, the face detection processing unit 1402 detects whether there is the face of the subject 1501 from the image data P1502 stored in the frame buffer 1401 by using the known algorithm such as the Viola-Jones method. In order to extract only the face of the subject 1501, face extraction address information P1503 is output.

The face detection address information P1503 is a rectangular area enclosing the face of the subject 1501. A start point address P1503a is address information of a top left corner of a rectangular area, and an end point address P1503b is address information of a bottom right corner of the rectangular area.

The feature point extraction unit 1403 performs processing, such as polygon analysis, on the image of the face of the subject 1501 included in partial image data specified by the face detection address information P1503. Then, the feature point data which include contours of the whole face, eyebrows, eyes, nose, mouth, and the like of the subject 1501, and feature points of the face indicating a pupil are generated. This is a feature point data P1504 of FIG. 15C. The feature point data P1504 is configured by an aggregate of feature points having coordinate information in a two-dimensional space. The feature point data P1504 is included in the range of face detection address information P1503.

[As to Face Detection Address Information P1503]

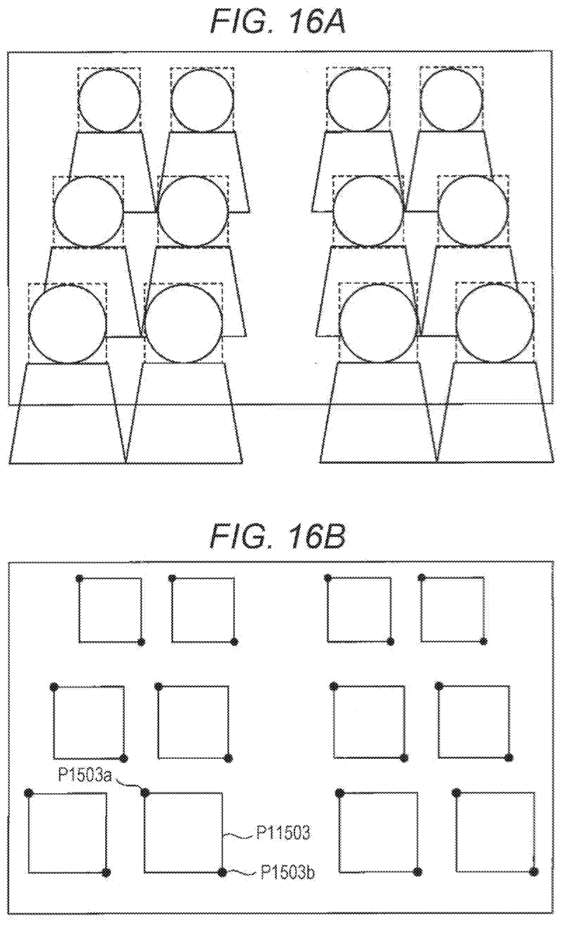

FIG. 16A is an image diagram showing the state in which the face detection processing unit 1402 generates face detection address information P1503 for the image data stored in the frame buffer 1401.

FIG. 16B is an image diagram showing the state in which the face detection processing unit 1402 has generated face detection address information P1503 for the image data stored in the frame buffer 1401.

The face detection processing unit 1402 detects the presence of the entire image area considered as a face of a person included in the image data as long as the resolution of the image data is permitted, and encloses the plurality of image areas in a rectangular shape. The address information of the top left corner and the bottom right corner of the rectangular area in this rectangular area is the face detection address information P1503.

Returning to FIG. 14, the description of the block diagram is continued.

An engagement calculation unit 1406 described later performs the moving average arithmetic processing in the calculation process of the engagement value. To calculate the moving average, it is necessary to continuously add a value based on an engagement value calculated from a certain subject over a certain time width. That is, it is necessary to specify the presence of a plurality of faces included in the image data stored in the frame buffer 1401 using the face detection address information P1503 or another information.

Therefore, the face detection address information P1503 is supplied to the address information processing unit 1407 included in the input/output control unit 1404.

The address information processing unit 1407 calculates a center point of an information shape area, that is, a center point of the face detection address information P1503 from the face detection address information P1503 output from the face detection processing unit 1402. Hereinafter, this center point is referred to as a face detection center point. The face detection center point is a point indicating the center of a face of a person reflected in the imaging device 1202 in a lesson, a course, a lecture or the like.

The face detection center point output from the address information processing unit 1407 is supplied to the engagement calculation unit 1406 included in the input/output control unit 1404. The engagement calculation unit 1406 handles the face detection center point as an individual identifier in the engagement calculation process described later.

[As to Engagement Value Arithmetic Processing]

The face detection vector and the line-of-sight direction vector output from the vector analysis unit 1405 is supplied to the engagement calculation unit 1406 included in the input/output control unit 1404. The engagement calculation unit 1406 calculates the engagement value from the face direction vector and the line-of-sight direction vector.

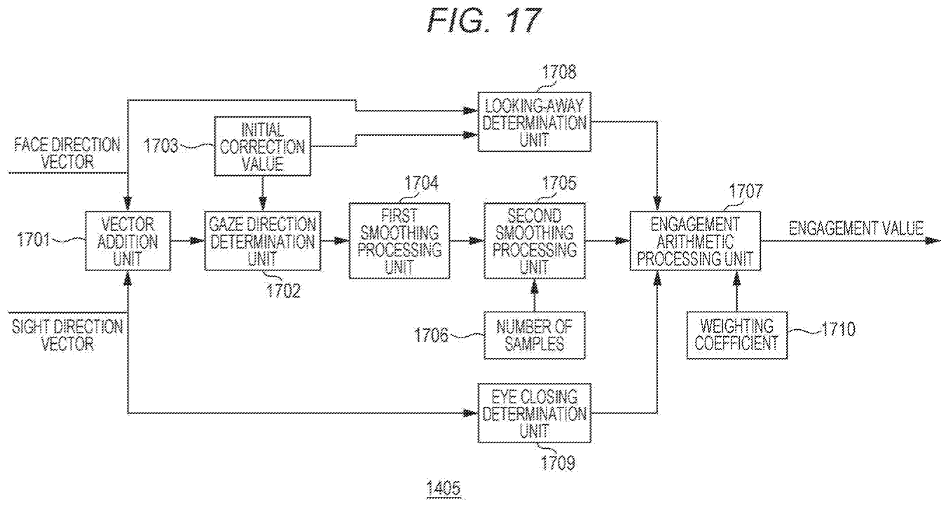

FIG. 17 is a functional block diagram of the engagement calculation unit 1406.

The face direction vector and the line-of-sight direction vector output from the vector analysis unit 1405 are input to a vector addition unit 1701. The vector addition unit 1701 adds the face direction vector and the line-of-sight direction vector to calculate the focus direction vector. The focus direction vector is a vector indicating a location in the three-dimensional space including the display unit 1208 displaying content and the imaging device 1202 at which the student 1207 focuses.

The focus direction vector calculated by the vector addition unit 1701 is input to a focus direction determination unit 1702. The focus direction determination unit 1702 outputs a binary focus direction determination result that determines whether the focus direction vector indicating an object which the student 1207 focuses at is directed to the display unit 1208.

When the imaging device 1202 is installed at a location away from the vicinity of the display unit 1208, the determination processing of the focus direction determination unit 1702 is corrected by the initial correction value 1703 stored in the nonvolatile storage 1305. In order to detect whether the face and line-of-sight of the student 1207 are correctly directed to the display unit 1208 in the initial correction value 1703, when the face and line-of-sight of the student 1207 are correctly directed to the display unit 1208 in advance, information on the face and line-of-sight directions of the student 1207 as viewed from the imaging device 1202 is stored in the nonvolatile storage 1305.

The binary focus direction determination result output from the focus direction determination unit 1702 is input to a first smoothing processing unit 1704. A disturbance derived from noise included in the feature point data generated by the feature point extraction unit 1403 often occurs in the focus direction determination result output from the focus direction determination unit 1702. Therefore, the first smoothing processing unit 1704 suppresses the influence of noise and obtains a “live engagement value” indicating a state very close to the behavior of the student 1207.

The first smoothing processing unit 1704 calculates, for example, a moving average of several samples including the current focus direction determination result, and outputs the live engagement value.

The live engagement value output from the first smoothing processing unit 1704 is input to a second smoothing processing unit 1705.

The second smoothing processing unit 1705 performs smoothing processing on the input live engagement value based on the number of samples 1706 designated in advance to output an “engagement basic value”. For example, if “5” is described in the number of samples 1706, the moving average is calculated for five live engagement values. In addition, in the smoothing processing, another algorithm such as a weighted moving average or an exponential weighted moving average may be used. The number of samples 1706 and the algorithm of the smoothing processing are appropriately set according to the application to which the engagement measurement system 1201 according to the second embodiment of the present invention is applied.

The engagement basic value output from the second smoothing processing unit 1705 is input to an engagement arithmetic processing unit 1707.

On the other hand, the face direction vector is also input to a looking-away determination unit 1708. The looking-away determination unit 1708 determines whether the face direction vector indicating the face direction of the student 1207 is directed to the display unit 1208, and generates a binary looking-away determination result. Then, according to a sampling rate of the face direction vector and the line-of-sight direction vector output from the vector analysis unit 1405, the looking-away determination result is counted by two counters (not shown) built in the looking-away determination unit 1708.

That is, the first counter counts the determination result that the student 1207 is looking away, and the second counter counts the determination result that the student 1207 is not looking away. The first counter is reset when the second counter reaches a predetermined count value. The second counter is reset when the first counter reaches a predetermined count value. Logical values of the first counter and the second counter are output as a determination result indicating whether the student 1207 is looking away.

In addition, by having the plurality of first counters in each direction, for example, taking a note by hand may not be determined to be looking aside according to an application.

In addition, the line-of-sight direction vector is also input to an eye closing determination unit 1709. The eye closing determination unit 1709 generates a binary eye closing determination result that determines whether the line-of-sight direction vector indicating the line-of-sight direction of the student 1207 can be detected.

The line-of-sight direction vector is detected only when the eyes of the student 1207 are open. That is, when the eyes of the student 1207 are closed, the line-of-sight direction vector cannot be detected. Therefore, the eye closing determination unit 1709 generates a binary eye closing determination result indicating whether the eyes of the student 1207 are closed.

The eye closing determination unit 1709 also includes two counters (not shown) in the same manner as the looking-away determination unit 1708, and the eye closing determination result by the eye closing determination unit 1709 is counted by two counters depending on the sampling rate of the face direction vector and the line-of-sight direction vector output from the vector analysis unit 1405.

The first counter counts the determination result in which the eyes of the student 1207 are closed, and the second counter counts the determination result in which the eyes of the student 1207 are open (the eyes are not closed). The first counter is reset when the second counter reaches a predetermined count value. The second counter is reset when the first counter reaches a predetermined count value. The logical values of the first counter and the second counter are output as a determination result indicating whether the eyes of the student 1207 are closed.

The engagement basic value output from the second smoothing processing unit 1705, the looking-away determination result output from the looking-away determination unit 1708, and the eye closing determination result output from the eye closing determination unit 1709 are input to the engagement arithmetic processing unit 1707.

The engagement arithmetic processing unit 1707 multiplies weighting coefficients 1710 by the engagement basic value, the looking-away determination result, and the eye closing determination result and adds the multiplied values according to the application to output a final engagement value.

By adjusting the number of samples 1706 and the weighting coefficients 1710, the engagement measurement system 1201 can be adapted to various applications. For example, if the number of samples 1706 is set to “0” and the weighting coefficients 1710 for the looking-away determination unit 1708 and the eye closing determination unit 1709 is also set to “0”, the live engagement itself output from the first smoothing processing unit 1704 is output from the engagement arithmetic processing unit 1707 as the engagement value as it is.

In particular, the second smoothing processing unit 1705 can be invalidated by the setting of the number of samples 1706. Therefore, the first smoothing processing unit 1704 and the second smoothing processing unit 1705 can be regarded as a single smoothing processing unit in a high level concept.

[As to Log Table 1408]

In the engagement measurement device 1203 according to the second embodiment of the present invention, in order to calculate the individual engagement value for a plurality of students 1207 or audiences, the input/output control unit 1404 uses the face detection address information P1503 and a log table 1408 to calculate the individual engagement values while keeping anonymity of a subject.

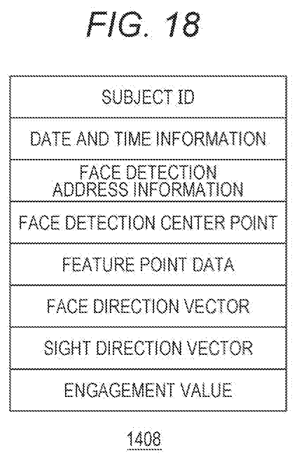

FIG. 18 is a diagram showing a field configuration of the log table 1408.

The log table 1408 has a subject ID field, a date and time information field, a face detection address information field, a face detection center point field, a feature point data field, a face direction vector field, a line-of-sight direction vector field, and an engagement value field.

A subject ID as ID information for uniquely identifying a person who is a subject in image data is stored in the subject ID field. The subject ID is merely used to avoid confusion of a person reflected in the image data at the time of the calculation of the engagement value, and is not for the purpose of strictly identifying the individual.

The date and time information field stores date and time when the image data stored in the frame buffer 1401 are captured. The date and time when the image data was captured can be calculated from the current date and time information output from the RTC 1306 in consideration of the data transmission speed between the imaging device 1202 and the frame buffer 1401, or the like. In addition, when the imaging device 1202 has the single board computer, it is possible to use capturing date and time information output from the RTC built in the single board computer. It is to be noted that there is substantially no problem with the current date and time information output from the RTC 1306, instead of the date and time when the image data was captured.

The face detection address information P1503 output from the face detection processing unit 1402 is stored in the face detection address information field.

The face detection center point calculated by the address information processing unit 1407 based on the face detection address information P1503 is stored in the feature point data field. This face detection center point is the basis of the subject ID.

The feature point data generated by the feature point extraction unit 1403 is stored in the feature point data field.

The face direction vector output from the vector analysis unit 1405 is stored in the face direction vector field.

The line-of-sight direction vector output from the vector analysis unit 1405 is stored in the line-of-sight direction vector field.

The engagement value calculated by the engagement calculation unit 1406 based on the face direction vector and the line-of-sight direction vector is stored in the engagement value field.

The address information processing unit 1407 of the input/output control unit 1404 associates the face detection center point calculated based on the face detection address information P1503 with the subject ID.

During a lesson or a lecture, the student 1207 or a student which is the subject is seated, and the position of the face does not move much. Therefore, the input/output control unit 1404 defines in advance as a threshold a range in which the face detection center point moves while the subject is in the audience. Then, if the face detection center point is within the range of the threshold value, the input/output control unit 1404 determines that the face detection center point belongs to the same subject ID.

When the face detection center point and the subject ID are associated with each other, the face detection address information P1503 based on the face detection center point, the feature point data existing in the range of the face detection address information P1503, and the face direction vector and the line-of-sight direction vector are uniquely associated with each other, and therefore the face direction vector and the line-of-sight direction vector are recorded in the same record of the log table 1408.

The face direction vector and the line-of-sight direction vector for a certain subject ID recorded in the log table 1408 are read by the engagement calculation unit 1406, and the engagement value is calculated and is recorded in the same record of the log table 1408.

An engagement average value calculation unit 1409 calculates average values of engagement values of a plurality of records belonging to the same date and time information recorded in the date and time information field of the log table 1408.

The input/output control unit 1404 performs predetermined processing on the average values of the engagement values output from the engagement average value calculation unit 1409, and displays the average values on the display unit 1208.

[Engagement Measurement Device 1203: Display Example]

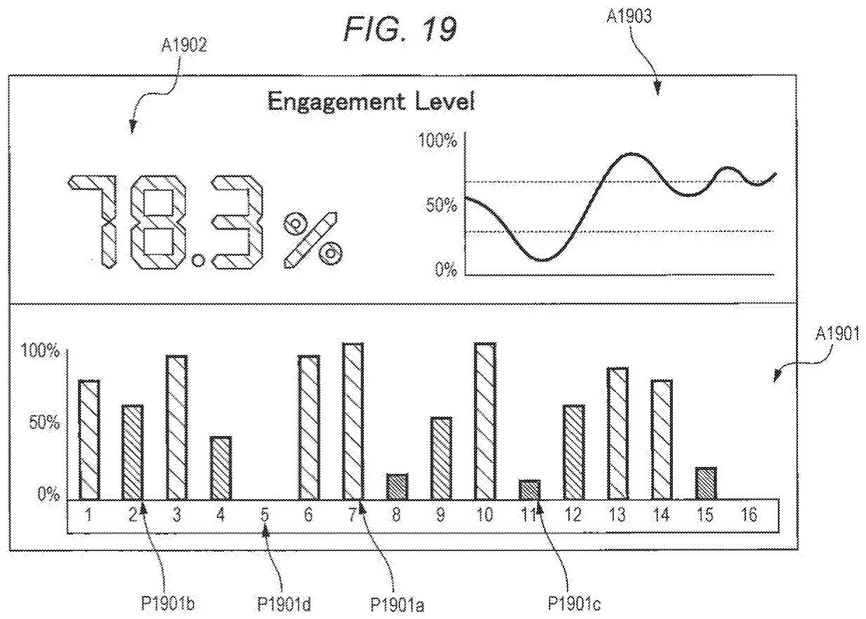

FIG. 19 is a display example of a monitor screen displayed on the display unit 1208 by the input/output control unit 1404 of the engagement measurement device 1203.

A display area A1901 in the lower half of the screen is a bar graph of each engagement value. The bar graph is refreshed, for example, every second or every 0.5 seconds, and the latest engagement value at that time is represented by the bar graph. When the engagement value is 66.6% or more, the bar graph is represented in green (color P1901a), and when the engagement value is 33.3% or more and less than 66.6%, the bar graph is represented in orange (color P1901b), and when the engagement value is less than 33.3%, the bar graph is represented in red (color P1901c). In this manner, by displaying the engagement values in different colors, it is possible to instantly grasp the state of the engagement values of the student 1207.

Numbers represented below the bar graph are numbers for uniquely identifying the student 1207 in the image data. The numbers may be the subject ID itself. The numbers are also represented in the same color as the bar graph. A number assigned to the engagement measurement device 1203, in which the student 1207 leaves on the way and which cannot measure the engagement value, is represented in gray (color P1901d).

For example, when all the students 1207 are interested in a lesson, all bar graphs are dyed green simultaneously except for a column of the engagement measurement device 1203 which represents the absence.

For example, when many of the students 1207 lose their concentration on a lesson, many bar graphs are dyed orange or red.

A display area A1902 on the upper left of the screen displays numerical values of the average values of all the engagement values. The numerical values are also represented in the same color as a line graph.

A display area A1903 on the upper right of the screen is a line graph representing a transition of the average values of all the engagement values. A horizontal axis is time, and a vertical axis is the engagement value. Since not only a current value of the engagement value but also the transition of the engagement value can be grasped by providing the line graph, a lecturer 1206 can grasp how much the students 1207 are interested in a current lecture or which topic the students 1207 are interested in or is not interested in.

Since the engagement value logged in the log table 1408 of the engagement measurement device 1203 includes date and time information, that is, absolute time information, the engagement value can be reproduced later by the engagement measurement device 1203 or another information processing device. In addition, if a lesson is recorded by a separate moving picture imaging device and information on date and time when recording starts is added to moving picture data, synchronous reproduction with the engagement value recorded in the log table 1408 is also possible.

The following modifications of the second embodiment of the present invention described above are possible.

(1) The imaging device 1202 used for the engagement measurement system 1201 captures a plurality of subjects and extracts feature point data of a face. Therefore, it is preferable that the imaging device 1202 have a resolution as high as possible, and it may not be possible to acquire the feature point data of the face due to the distance between the imaging device 1202 and the subject. Therefore, a plurality of imaging devices 1202 are disposed in a classroom or an auditorium in which the engagement measurement system 1201 is installed in consideration of the angle of view and the range in which the imaging device 1202 can capture an image. Then, the same image data stream output from the plurality of imaging devices 1202 is appropriately combined or subjected to trimming processing. Thereafter, storing the combined image data in the frame buffer 1401 makes it possible to measure the engagement values of the plurality of objects in a wide range.

(2) By processing the image data and the face detection address information P1503 stored in the frame buffer 1401 by the known face recognition processing, it becomes possible to specify an individual more accurately. The ability to precisely identify individuals can be expected to improve the accuracy of calculation of the engagement values.

(3) The engagement average value calculation unit 1409 of the input/output control unit 1404 and the display unit 1208 are mounted on another device such as a tablet PC, connected to each other by a network such as a wireless LAN, and broadcasts data recorded in the log table 1408 through the network, such that it is possible to perform the display of the engagement measurement device 1203 even at a remote location. If data are transmitted to a plurality of display devices, a display can be performed at a plurality of points. In addition, the transmitted data may be recorded in the server and reproduced later. By doing so, it is possible to confirm the result of the engagement measurement, for example, at an office or a head quarter in a remote location, which is different in place and time from the classroom 1205 in which the engagement measurement is performed, or even at later date.

(4) The average value of the engagement measurement values shown in FIG. 19 is just an average value. That is, the imaging device 1202 does not necessarily have to capture images of all the students 1207 and the audience seated in a classroom or an auditorium. The number of persons capable of measuring the engagement value at the resolution of the imaging device 1202 may be the number of samples sufficient to calculate the average value.

In the second embodiment of the present invention, the engagement measurement system 1201 has been disclosed.

The engagement measurement device 1203 captures the image of the student 1207 that is a plurality of subjects using a single or a small number of imaging devices 1202, and measures the engagement value indicating how much the student 1207 is interested in a lesson. The engagement measurement device 1203 records the subject ID, the date and time information, and the engagement value in the log table 1408. The engagement measurement device 1203 graphically displays the average value of the engagement values in real time.

Hereinabove, although the embodiment of this invention has been described, the present invention is not limited to the embodiment, and other modifications and applications are carried out without departing from the scope of the present invention described in the apprehend claims.

### REFERENCE SIGNS LIST

101 Engagement measurement system
102 Cram school
103 Lecturer
104 Student
105 Desk
106 Engagement measurement device
107 Wireless LAN router
108 Server
109 Monitor terminal
301 Notebook computer
302 LCD display
303 Web camera
304 Single board computer
305 Camera
401 CPU
402 ROM
403 RAM
404 Nonvolatile storage
405 RTC
406 Wireless LAN interface
407 NIC
408 Bus
409 Imaging device
501 Face detection processing unit
502 Feature point extraction unit
503 Vector analysis unit
504 Engagement calculation unit
505 Input/output control unit
506 ID information
507 Interface selection unit
601 Subject
701 CPU
702 ROM
703 RAM
704 Display unit
705 Operation unit
706 Nonvolatile storage
707 RTC
708 NIC
709 Bus
801 Input/output control unit
802 Log table
803 Input/output control unit
804 Display processing unit
805 Totalization processing unit
901 CPU
902 ROM
903 RAM
904 Display unit
905 Operation unit
906 Nonvolatile storage
907 RTC
908 Wireless LAN interface
909 Bus
1001 Input/output control unit
1002 Totalization processing unit
1003 Display processing unit
1201 Engagement measurement system
1202 Imaging device
1203 Engagement measurement device
1204 Cable
1205 Classroom
1206 Lecturer
1207 Student
1208 Display unit
1301 CPU
1302 ROM
1303 RAM
1304 Operation unit
1305 Nonvolatile storage
1306 RTC
1307 NIC
1308 Bus
1401 Frame buffer
1402 Face detection processing unit
1403 Feature point extraction unit
1404 Input/output control unit
1405 Vector analysis unit
1406 Engagement calculation unit
1407 Address information processing unit
1408 Log table
1409 Engagement average value calculation unit
1501 Subject
1701 Vector addition unit
1702 Focus direction determination unit
1703 Initial correction value
1704 First smoothing processing unit
1705 Second smoothing processing unit
1706 The number of samples
1707 Engagement arithmetic processing unit
1708 Looking-away determination unit
1709 Eye closing determination unit
1710 Weighting coefficient

1. An engagement measurement system, comprising:
an imaging device that captures images of faces of a plurality of subjects; and
an engagement measurement device that receives a moving picture data stream from the imaging device to measure engagement values of the plurality of subjects,
wherein the engagement measurement device includes:
a frame buffer that stores image data corresponding to one screen from an image data stream output from the imaging device;
a face detection processing unit that detects whether there are the faces of the plurality of subjects from the image data stored in the frame buffer and outputs face detection address information for extracting only the faces of the plurality of subjects;
a feature point extraction unit that outputs feature point data, which are an aggregate of feature points having coordinate information in a two-dimensional space of the faces of the plurality of subjects, from the image data and the face detection address information stored in the frame buffer;
a vector analysis unit that generates a face direction vector indicating a face direction of the subject from the feature point data;
an engagement calculation unit that calculates the face direction vector to calculate a focus direction vector indicating a location in a three-dimensional space at which the subject focuses, determines whether the focus direction vector is directed to a predetermined event, and calculates a moving average of the determination results to output the engagement values;
an input/output control unit that operates the engagement calculation unit to calculate the engagement values for each of the plurality of subjects included in the image data based on the face detection address information and records capturing date and time information or current date and time information of the image data and ID information for uniquely identifying a plurality of subjects in the image data in a log table;
an engagement average value calculation unit that calculates an average value of the engagement values; and
a display unit that displays the average value of the engagement values of the plurality of subjects.

2. The engagement measurement system according to claim 1, wherein
the vector analysis unit generates a line-of-sight direction vector indicating a line-of-sight direction of the face of the subject as well as the face direction vector indicating the face direction of the subject from the feature point data, and
the engagement calculation unit calculates the focus direction indicating a location in a three-dimensional space at which the subject focuses by adding the line-of-sight direction vector, in addition to the face direction vector.

3. The engagement measurement system according to claim 2, wherein
the input/output control unit displays the engagement values of the plurality of subjects and the average value in different colors based on a predetermined threshold.

4. An engagement measurement system, comprising:
a plurality of engagement measurement devices that measure engagement values of a plurality of subjects;
a server that receives a transmission packet from the engagement measurement device to perform log recording; and
a monitor terminal that displays the engagement value output from the engagement measurement device in real time,
wherein the engagement measurement device includes:
an imaging device that captures an image of a face of the subject;
a face detection processing unit that detects whether there is the face of the subject from an image data stream output from the imaging device and outputs face extraction image data obtained by extracting the face of the subject;
a feature point extraction unit that outputs feature point data, which are an aggregate of feature points having coordinate information in a two-dimensional space of the face of the subject, from the face extraction image data;
a vector analysis unit that generates a face direction vector indicating a face direction of the subject and a line-of-sight direction vector indicating a line-of-sight direction of the face of the subject from the feature point data;
an engagement calculation unit that adds the face direction vector and the line-of-sight direction vector to calculate a focus direction vector indicating a location in a three-dimensional space at which the subject focuses, determines whether the focus direction vector is directed to a predetermined event, and calculates a moving average of the determination results to output the engagement values;
a real time clock that outputs current date and time information; and
an input/output control unit that generates a transmission packet by collecting the engagement value output from the engagement calculation unit, the current date and time information output from the real time clock, and ID information for uniquely identifying an individual of the subject and another engagement measurement device, and transmits the generated transmission packet to the server,
the server includes:
a log table in which the transmission packet transmitted from the plurality of engagement measurement devices is logged; and
an input/output control unit which receives the transmission packet transmitted from the plurality of engagement measurement devices and records the received transmission packet in the log table, and
the monitor terminal includes:
an input/output control unit that receives the transmission packet, which is generated by the plurality of engagement measurement devices, from the plurality of engagement measurement devices or the server;
a totalization processing unit that calculates an average value of the engagement values included in the transmission packet received from the plurality of engagement measurement devices by the server;
a display unit that displays the engagement value and the average value; and
a display processing unit that forms a display screen of the engagement value and the average value displayed on the display unit.

5. The engagement measurement system according to claim 4, wherein
the display processing unit of the monitor terminal displays the engagement value and the average value in different colors based on a predetermined threshold.
